(19) United States
(12) Patent Application Publication
(10) Pub. No.: US 2007/0262715 A1
(43) Pub. Date: Nov. 15, 2007

(54) Plasma display panel with low voltage material

(75) Inventors: Qun Yan, Walkill, NY (US); George H. Gries JR., Walkill, NY (US); Norman H. Clausen, Kingston, NY (US)

Correspondence Address: Paul D. Greeley, Esq.;Ohlandt, Greeley, Ruggiero & Perle, L.L.P., 10th Floor, One Landmark Square, Stamford, CT, 06901-2682, US

(73) Assignee: MATSUSHITA ELECTRIC INDUSTRIAL CO., LTD.

(21) Appl. No.: 11/432,143

(22) Filed: May 11, 2006

(51) Int. Cl. H01J 17/49

(52) U.S. Cl. 313/582

(57) ABSTRACT

A gas discharge device having a plurality of electrodes; and a low voltage protective layer deposited onto the electrodes such that the plurality of electrodes and the low voltage protective layer form a vessel containing a dischargeable gas so that at least the low voltage protective layer is exposed to the dischargeable gas. Also provided is a plasma display panel, including a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes and being in spaced adjacency therewith; a red phosphor layer, a green phosphor layer and blue phosphor layer sequentially disposed on top of the dielectric layer between the barrier ribs; and a low voltage protective layer deposited on top of dielectric layer that covers the scan electrodes and sustain electrodes on the front plate such that the front plate and the back plate form a panel containing a dischargeable gas so that at least the low voltage protective layer and the phosphor layers are exposed to the dischargeable gas.

### BACKGROUND OF THE INVENTION

1. Field of the Invention

The present invention relates to a gas discharge device having a plurality of electrodes and a low voltage protective layer deposited onto the electrodes. More particularly, the present invention relates to a plasma display panel, which includes a front plate having scan electrodes and sustain electrodes covered by dielectric layer and a low voltage protective layer; a back plate having a plurality of column address electrodes; a dielectric layer; a plurality of barriers; and red, green and blue phosphor layers.

2. Description of the Related Art

Most commercial plasma display panels (PDP's) are of the surface discharge type. The constitution of a plasma display panel of the prior art is described below with reference to the accompanying drawing.

FIG. 1 is a perspective view of a portion of a conventional AC color plasma display panel. AC PDP includes a front plate assembly and a back plate assembly. Front plate assembly includes a front plate 110, which is a glass substrate, sustain electrodes 111 and scan electrodes 112 for each row of pixel sites. Front plate assembly also includes a dielectric glass layer 113 and a protective layer 114. Protective layer 114 is preferably made of magnesium oxide (MgO).

Back plate assembly includes a glass back plate 115 upon which plural column address electrodes 116, i.e., data electrodes, are located. Data electrodes 116 are covered by a dielectric layer 117. Barrier rib 118 is on back plate assembly. Red phosphor layer 120, green phosphor layer 121, and blue phosphor layer 122 are located on top of the dielectric layer 117 and along the sidewalls created by barriers rib 118. Each pixel of PDP is defined as a region proximate to an intersection of (i) a row including sustain electrode 111 and scan electrode 112, and (ii) three column address electrodes 116, one for each of red phosphor layer 120, green phosphor layer 121, and blue phosphor layer 122.

FIG. 2 is a side view of a portion of PDP, specifically of a sub-pixel 200 corresponding to green phosphor layer 221, taken along a plane perpendicular to a long dimension of address electrode 216. Referring to FIG. 2, in a surface discharge type PDP, an inert gas mixture, such as Ne—Xe, fills a space 225 between front plate assembly and back plate assembly.

Barrier ribs 218 separate color channels formed by barrier ribs 218, on the back plate assembly. Sub-pixels 200 are formed as an area bounded by the sides of barrier ribs 218 and the area defined by sustain electrodes 211. A gas discharge is generated by a voltage applied between sustain electrode 211 and scan electrode 212 (not shown in the figure), which creates vacuum ultraviolet (VUV) light that excites the red, green, and blue phosphor layers, respectively to emit visible light. For example, green phosphor 221, as shown in FIG. 2, is excited by the VUV light to generate green light from green phosphor layer 221.

FIG. 3 is another side view of PDP, taken along a plane parallel to the long dimension of address electrode 216, and showing sub-pixel 200 in a plane perpendicular to the plane of FIG. 2. FIG. 3 shows a sub-pixel, which is defined as an area that includes intersections of an electrode pair of a transparent sustain electrode 311 and scan electrode 312 on front plate, and data electrode 316 on back plate. Transparent sustain electrode 311 has an adjacent bus electrode 310 connected thereto, and transparent scan electrode 312 has an adjacent bus electrode 313 connected thereto. Bus electrodes 310 and 313 are typically opaque.

The operating sustain voltage of PDP is determined by a geometry of a sustain gap 330, dielectric layers, the particular gas mixture used, and a secondary electron emission coefficient of the protective MgO layer 314 on front plate. The visible light generated in the sustain discharges is responsible for the brightness of a color PDP.

Initiation of sustain discharges is achieved by an addressing discharge through a plate gap 331 prior to sustain discharges, which is further described below. A full color image is generated by appropriately controlling the driving voltage on sustain electrodes 311, scan electrodes 312, and addressing electrodes 316.

In operation, as shown in FIG. 4, the plasma display partitions a frame of time into sub-fields, each of which produces a portion of the light required to achieve a proper intensity of each pixel. Each sub-field is partitioned into a setup period, an addressing period and a sustain period. The sustain period is further partitioned into a plurality of sustain cycles.

The setup period resets any ON pixels to an OFF state, and provides priming to the gas and to the surface of protective layer 114 to allow for subsequent addressing. In the setup period, it is desirable that each interior surface of the pixel's electrodes is placed at a voltage very close to a firing voltage of the gas.

During the addressing period, the sustain electrodes are driven with a common potential, while scan electrodes are driven such that a row of pixels is selected so that pixels in that row can be addressed via an addressing discharge triggered by an application of a data voltage on a vertical column electrode. Thus, during the addressing period, each row is sequentially addressed to place desired pixels in the ON state.

During the sustain period, a common sustain pulse is applied to all scan electrodes to repetitively generate plasma discharges at each sub-pixel addressed during the addressing period. That is, if a sub-pixel is turned ON during the address period, the pixel is repetitively discharged in the sustain period to produce a desired brightness.

In order to exhibit a full color image on a plasma display panel (PDP) from a video source, a proper driving scheme is needed to achieve sufficient gray scale and minimize motion picture distortion. In AC plasma display panels, a widely used driving scheme to accomplish gray scale in pixels is the so called ADS (address display separated) suggested by Shinoda (Yoshikawa K, Kanazawa Y, Wakitani W, Shinoda T and Ohtsuka A, 1992 Japan. Display 92, 605).

Referring to FIG. 4, it can be seen that in this method, a frame time of 16.7 milliseconds (one TV field) is divided into eight sub-fields, designated as SF1-SF8. Each of the eight sub-fields is further divided into an address period and a sustain period, i.e., display period. Pixels previously addressed during address period are turned on and emit light during sustain period. The duration of sustain period depends on the particular sub-field. By controlling the addressing of each sub-pixel for a given pixel during addressing period, the intensity of the pixel can be varied to any of the 256 gray scale levels.

The luminous efficacy of PDPs is very important issue for plasma TV application. The efficiency should be further improved to lower the cost of electronics and to reduce energy cost for the consumers. The luminous efficacy of a PDP is defined as the ratio of the visible luminous flux to the input power. The luminous efficacy of a PDP is determined by the efficiency of UV generation from sustain discharges, the efficiency of visible light generation from UV radiated phosphors, and the efficiency of transmitting visible light from the discharge cells.

The low luminous efficacy of PDP (compared to fluorescence lamp) is mainly due to the lower efficiency of UV generation from the discharge.

In a typical PDP discharge, most energy is lost in ion heating in the sheath and smaller percentage energy (about 40% or less) is used for electron heating. The energy dissipated in electron heating is used for excitation and ionization of Xenon and Neon atoms. The UV generation is from the excitation of the Xenon. Therefore the efficiency of UV generation is strongly tied to the percentage of energy is used for electron heating. It is generally believed that higher secondary electron emission leads to lower percentage of energy used for ion heating and higher percentage energy dissipated by electrons.

The secondary-electron emission from the protective layer in a discharge may include contributions due to ion-induced, photon induced, metastable-induced, etc. processes.

In a typical AC PDP discharge, the secondary electron emission is dominated by very low energy ions (the average energy of ions is in the order of a few eV) bombardment of cathode surface. The ion-induced secondary electron emission is due to Auger neutralization and resonance neutralization followed by Auger de-excitation.

FIG. 5 shows a schematic diagram of the electron emission through Auger neutralization process developed by Hagstrum (H. D. Hagstrum, Phys. Rev., 96, 336, (1954)).

As an ion with ionization energy Ei approaches the insulator surface, it can capture an electron in the valence band to become neutralized and simultaneously excited a second electron to higher energy level through the energy gain by the neutralization. If the excited electron exceeds the surface barrier it can escape from the surface and becomes a secondary electron.

The maximum kinetic energy at which the secondary electrons are ejected equals
Eₖ(max)=Eᵢ−2(E_{g}+χ)
with χ being the electron affinity, E_{g} is the band gap energy of the solid, and Eᵢ is the ionization energy of the gas ion. In an AC color PDP, a gas mixture of Neon and Xenon is used for gas discharge.

The secondary electron emissions are contributed by Ne ions and Xe ions. Since the ionization energy Eᵢ of Ne is 21.7 eV, there is enough energy for Auger electrons to be emitted because Eᵢ−2(E_{g}+χ)=21.7−2(7.8+1.3)=3.5>0 for MgO. However, the secondary electron emission induced by Xe ion is almost zero because the ionization energy of Xe is 12.1 eV and Eᵢ−2(E_{g}+χ)=12.1−2(7.8+1.3)=−6.1 <0.

In a Ne—Xe gas mixture, the effective secondary electron emission coefficient γ_{eff}, the effective electrons emission per incoming ion in a Ne—Xe gas mixture discharge, is smaller than γ_{Ne}, the secondary electron emission coefficient by neon ion, since xenon ions are dominant especially in higher Xe content gas mixture. In order to achieve high percentage of energy dissipated in electron heating which can lead to high efficiency of UV generation, high effective secondary electron emission, in other words, the secondary electron emission induced by low energy Xe ion is required.

Based on the criteria of Auger electron process, a film with the sum of band gap energy and electron affinity energy E_{g}+χ<6.1 eV is necessary for secondary electron emission induced by Xe ions. It is clear the regular MgO film can not meet the criteria because the MgO band gap is too big. Accordingly, it is an object of this invention is to develop new protective film that can meet the above criteria.

Replacing MgO film with lower band gap and/or lower electron affinity film is a key theme of the present invention.

### SUMMARY OF THE INVENTION

An object of the present invention is to create a new protective layer operating in a lower voltage (compared to conventional MgO protective layer) for improving luminous efficacy of plasma display panels (PDP).

Accordingly, the present invention provides a gas discharge device having a plurality of electrodes; and a low voltage protective layer deposited onto the electrodes such that the plurality of electrodes and the low voltage protective layer form a vessel containing a dischargeable gas so that at least the low voltage protective layer is exposed to the dischargeable gas.

The present invention further provides a plasma display panel, which includes a front plate having scan electrodes and sustain electrodes for each row of pixel sites covered by a dielectric layer and a low voltage protective layer deposited on top of the dielectric layer; a back plate having a plurality of column address electrodes disposed thereon; a dielectric layer covering the column address electrodes; a plurality of barrier ribs disposed above the dielectric layer separating the column address electrodes and being in spaced adjacency therewith; a red phosphor layer, a green phosphor layer and blue phosphor layer sequentially disposed on top of the dielectric layer between the barrier ribs; and a low voltage protective layer deposited between the scan electrodes and sustain electrodes on the front plate such that the barrier ribs between the front plate and the low voltage protective layer form a vessel containing a dischargeable gas so that at least the low voltage protective layer and the phosphor layers are exposed to the dischargeable gas.

The present invention still further provides a plasma display panel, which includes a front plate having scan electrodes and sustain electrodes for each row of pixel sites; a back plate having a plurality of column address electrodes disposed thereon; a dielectric layer covering the column address electrodes; a plurality of barrier ribs disposed above the dielectric layer separating the column address electrodes and being in spaced adjacency therewith; a red phosphor layer, a green phosphor layer and blue phosphor layer sequentially disposed on top of the dielectric layer between the barrier ribs; and a low voltage protective layer deposited on top of dielectric layer that covers scan electrodes and sustain electrodes on the front plate such that the barrier ribs between the front plate and the low voltage protective layer form a vessel containing a dischargeable gas so that at least the low voltage protective layer and the phosphor layers are exposed to the dischargeable gas.

The present invention still further provides a composition represented by the formula:
MₓMg₁₋ₓO

wherein x is 0.01<x<1;

wherein M is a metal selected from: Be, Ca, Sr, Ba, Ra, Sc, Y, Ti, Zr, Hf, V, Nb, Ta, Zn, Na, Al, and mixtures thereof; and

wherein the composition is in the form of a low voltage protective layer having a band gap from about 3.5 eV to about 7 eV.

These and other aspects of the present invention will be better understood by the specification with reference to the drawings.

### BRIEF DESCRIPTION OF THE DRAWINGS

FIG. 1 is a perspective view of a conventional color plasma display structure according to the prior art.

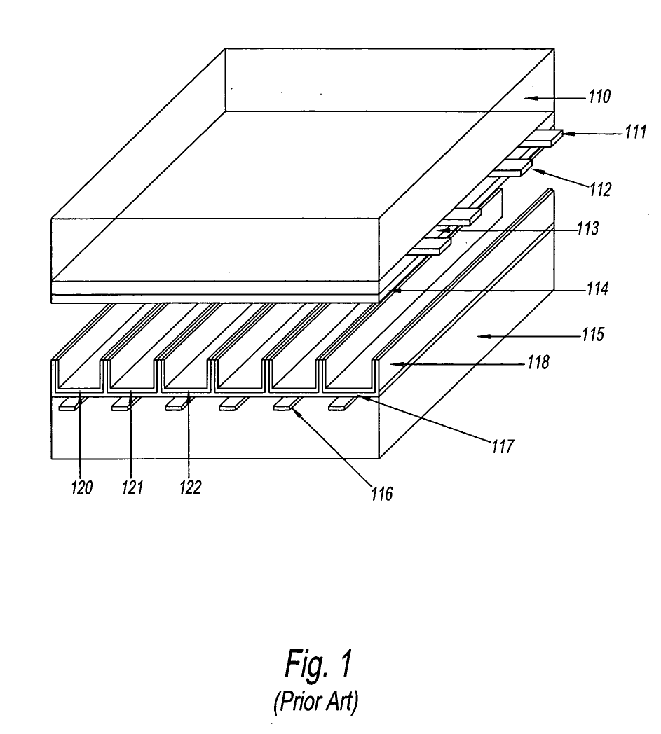

FIG. 2 is a side view of a sub-pixel of the color plasma display panel of FIG. 1, taken along a plane perpendicular to a long dimension of an address electrode.

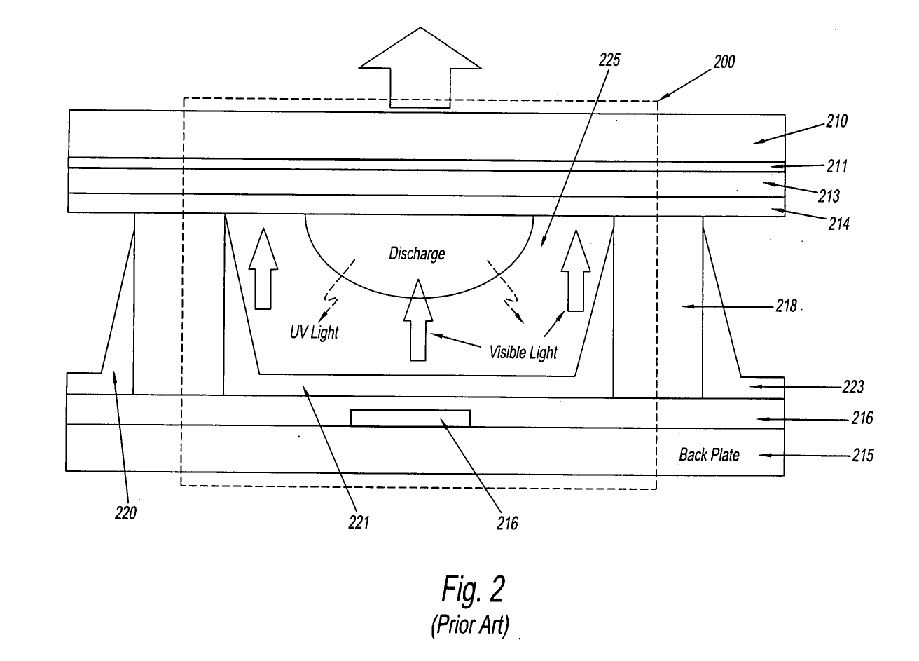

FIG. 3 is another side view of a sub-pixel of the color plasma display panel of FIG. 1, taken along a plane parallel to the long dimension of the address electrode, and showing the sub-pixel in a plane perpendicular to the plane of FIG. 2.

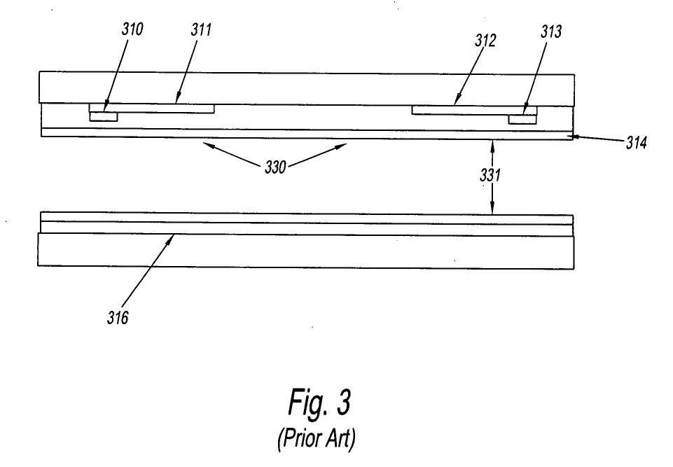

FIG. 4 is a diagram of a driving scheme of an address display separation (ADS) gray scale technique, showing a frame time divided into sub-fields (prior art).

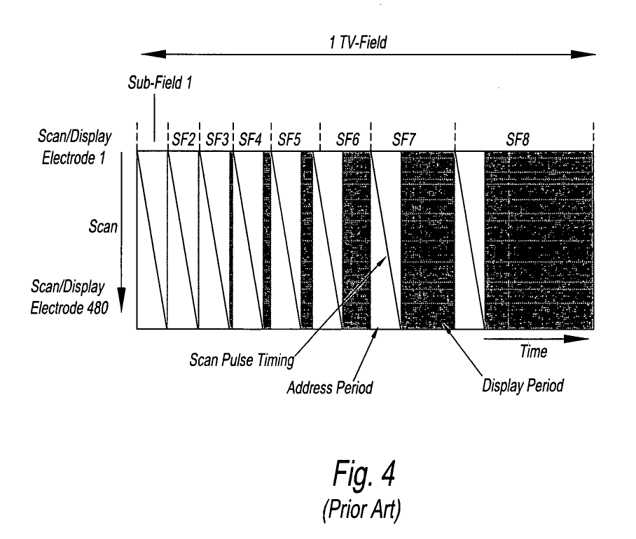

FIG. 5 is a schematic diagram of Auger neutralization process (prior art).

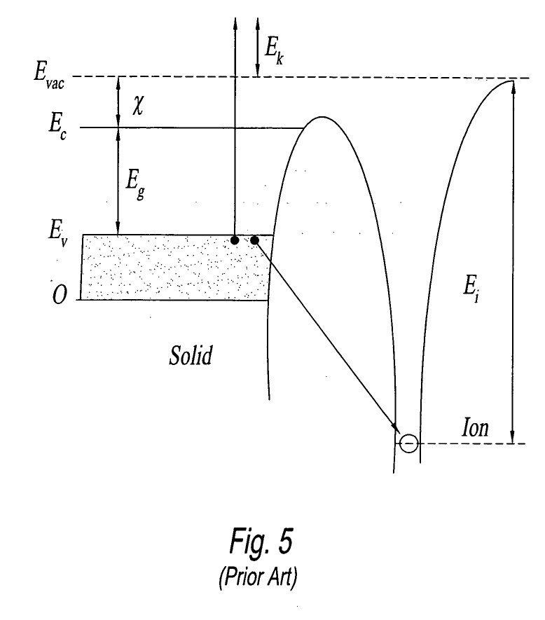

FIG. 6 shows the discharge voltage of a test panel with newly developed BaₓMg₁₋ₓO layer in different Ne—Xe gas mixture and its comparison to normal MgO layer.

FIG. 7 shows relative luminous efficacy of a test panel with newly developed BaₓMg₁₋ₓO layer in different Ne—Xe gas mixture and their comparison to normal MgO layer. The luminous efficacy is normalized to the efficacy of a test panel with normal MgO layer in 7% Xe—Ne gas mixture.

FIG. 8 shows minimum sustain voltage of 13″ test panels with various newly developed CaₓMg₁₋ₓO layer in 15% Xe—Ne gas mixture and their comparison to a normal MgO panel with same gas mixture.

FIG. 9 shows luminous efficacy of 13″ test panels with various newly developed CaₓMg₁₋ₓO layer in 15% Xe—Ne gas mixture and their comparison to a normal MgO panel with same gas mixture.

### DESCRIPTION OF THE PREFERRED EMBODIMENTS

As mentioned above, an object of the present invention is to create a new protective layer operating in a lower voltage (compared to conventional MgO protective layer) for improving luminous efficacy of plasma display panels (PDP).

The low voltage performance is achieved by increasing the effective secondary electron emission from the new protective layer under discharge of inert gas mixture of Neon and Xenon. The low voltage caused by the effective secondary electron emission can increase luminous efficacy of plasma display panels. The low operating voltage includes low sustain voltage and low addressing voltage. Low sustain voltage can also reduce the erosion rate of the protection layer and prolong the lifetime of the panel. The lower addressing voltage can reduces the cost of data driving circuits.

Accordingly, an essential aspect of the present invention is the use of a new protective layer in discharge devices and plasma display panels. The term protective layer refers to a thin insulating layer having a mixture of alkaline earth metal oxides with Magnesium oxide, or/and mixture of Magnesium oxide with other oxide materials, such as, Scandium oxide, Yttrium oxide, Zinc oxide, Titanium oxide, Vanadium oxide, Hafnium oxide, Tantalum oxide, and/or multi-mixture of these materials.

Preferably, the new protection layer is formed by co-deposition of two or more of the materials mentioned.

The low voltage protective layer includes a material represented by the formula:
MₓMg₁₋ₓO

wherein x is 0.01<x<1; more preferably x is 0.01<x<0.5; and

wherein M is a metal selected from Be, Ca, Sr, Ba, Ra, Sc, Y, Ti, Zr, Hf, V, Nb, Ta, Zn, Na, Al, and mixtures thereof. Preferably, M is a metal selected from Be, Ca, Sr, Ba, Ra, and mixtures thereof.

The protective layer is formed by co-deposition of two or more of materials mentioned. The preferred low voltage protective layer has a band gap about 3.5 eV to about 7 eV. Thus, these materials create lower band gap than conventional MgO material and, as a result, the AC plasma display panel can operate in lower operating voltage and higher luminous efficacy. The lower operating voltage also leads to lower electronic cost of plasma display panel.

In order to achieve these objectives, a special sealing process is required to prevent new protection layer from contamination that can cause higher driving voltage and poor exo-electron emission (poor priming condition for addressing discharge). The un-contaminated protective layers help to significantly reduce the operating voltage of an AC plasma display panel. Accordingly, the discharge device and the plasma display are sealed in a moisture and/or CO₂ free environment or are sealed in an evacuated environment.

In order to achieve the advantages of the new protective layer, a sealing process is employed to prevent new protection layer from contamination, which can cause higher driving voltage and poor exo-electron emission (poor priming condition for addressing discharge). The present invention includes low voltage protective layer (compared to MgO layer) in a discharge device. The low voltage protective layer is deposited on top of the dielectric layer that covers electrodes and is directly exposed to dischargeable gas. The electrode can also be covered directly by the low voltage protective layer.

Examples of the low voltage protective layer material MₓMg₁₋ₓO in the gas discharge device according to the present invention include a mixture of alkaline earth metal oxides with Magnesium oxide, or/and mixture of Magnesium oxide with following oxide material, Scandium oxide, Yttrium oxide, Zinc oxide, Titanium oxide, Vanadium oxide, Hafnium oxide, Tantalum oxide, Zirconium oxide, Aluminum oxide, or a combination thereof.

In the formula, M represents Beryllium, Calcium, Strontium, Barium, Radium, Scandium, Yttrium, Zinc, Titanium, Vanadium, Hafnium, Tantalum, Aluminum, and Zirconium or combination thereof. More Preferably, M is an alkaline earth metal, such as, Be, Ca, Sr, Ba, or Ra. More preferably, M is a metal, such as, Be, Ca, Sr, Ba, Ra, or mixtures thereof.

The atomic concentration x of doped metal into MgO is in the range of 0.01 to 1 and preferably from 0.01 to 0.5.

To achieve the above concentration, the new protective layer can be formed by co-deposition of Magnesium oxide and other alkaline earth metal oxides or following oxide material, Scandium oxide, Yttrium oxide, Zinc oxide, Titanium oxide, Vanadium oxide, Hafnium oxide, Tantalum oxide, and any mixtures of these compounds. The low voltage protective layer is formed either by co-deposition of magnesium oxide and oxides of the above metals or co-deposition of the oxides of the metals.

The new protective layer is formed by co-deposition of two or more of the materials mentioned. The co-deposition can be done through e-beam evaporation of two or more source material and the composition of the film is determined by the deposition condition of individual e-beam source. The co-deposition can also be accomplished by sputtering of two or more of the materials mentioned.

The new protective layer can also be formed by depositing of the premixed materials mentioned. The deposition can be accomplished by e-beam evaporation of premixed source materials mentioned. The deposition can also be accomplished by sputtering of premixed target materials mentioned. The film can also be deposited by reactive sputtering from target material that mixed from magnesium with those metals such as, Beryllium, Calcium, Strontium, Barium, Radium, Scandium, Yttrium, Zinc, Titanium, Vanadium, Hafnium, Tantalum, Aluminum, and Zirconium in oxygen environment.

The new protective layer can be formed by other deposition techniques, such as chemical vapor deposition (CVD), molecular beam epithaxy (MBE), inkjet printing, screen printing, and spin coating. And the new protective material can also be put on partial area instead of whole protective layer.

In a preferred embodiment, the low voltage protective layer is formed by co-deposition of premixed oxides of the metals. The co-deposition of the premixed oxides is preferably carried out by a method selected from e-beam evaporation, sputtering, chemical vapor deposition (CVD), molecular beam epithaxy (MBE), inkjet printing, screen printing, and spin coating.

Special care is required to prevent the low voltage layer from contamination of moisture and carbon dioxide in the air. An extra thin layer, defined as anti-contamination layer, can be used for preventing surface from chemical reaction of moisture and carbon dioxide with low voltage layer. The anti-contamination layer is made of following material: BeO, MgO, Al₂O₃, SiO₂, and/or a mixture of these materials. Another way to overcome the problem is to seal the panel in a dry and CO₂ free environment, or dry Nitrogen environment, or dry noble gas environment, or other non-reacting gas environment, or to seal in vacuum.

Preferably, the dischargeable gas includes at least one element, such as, Xenon, Neon, Argon, Helium, Krypton, Mercury, Nitrogen, Oxygen, Fluorine and Sodium.

Preferably, the low voltage protective layer is formed by co-deposition of premixed metals by reactive sputtering in an oxygen environment.

### EXAMPLE 1

The newly developed BaₓMg₁₋ₓO (0.01<x<1) film was formed by e-beam co-deposition of BaO and MgO. The film can also be formed by e-beam deposition from a single source material that is the mixture of BaO and MgO. The test panel using BaₓMg₁₋ₓO instead of MgO film was fabricated in different gas mixture.

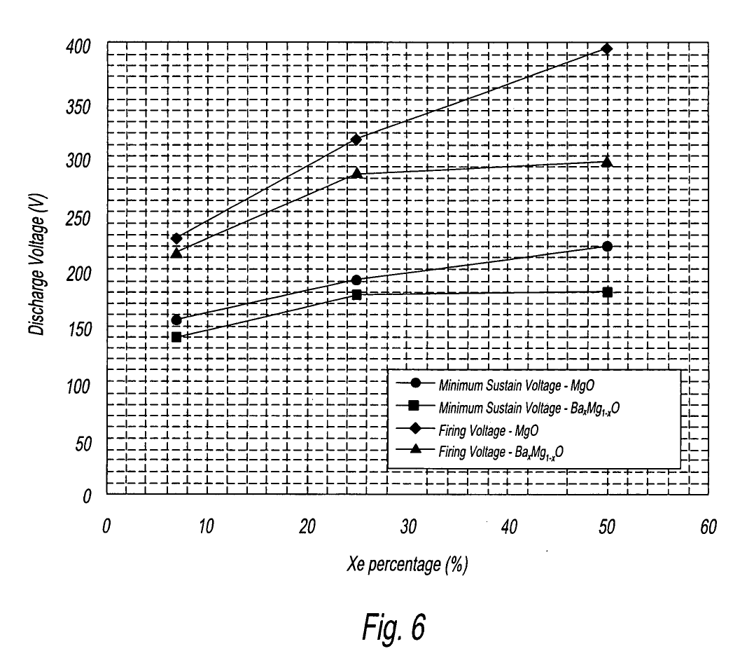

Referring to FIG. 6, the discharge voltage of a test panel with newly developed BaₓMg₁₋ₓO layer in different Ne—Xe gas mixture and its comparison to normal MgO layer is shown.

In FIG. 6, the minimum sustain voltage of BaₓMg₁₋ₓO layer is 15V to 40V lower than conventional MgO layer from 7% to 50% Xe—Ne gas mixture. The firing voltage difference between BaₓMg₁₋ₓO and MgO is even more significant, the reduction of firing voltage of BaₓMg₁₋ₓO layer are 13V at 7% Xe, 30V at 25% Xe, and 100V at 50% Xe.

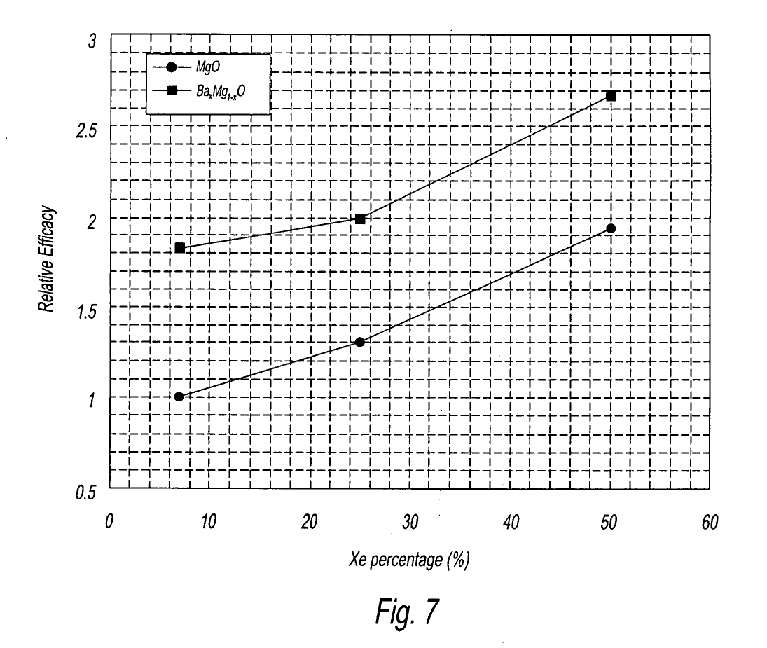

FIG. 7 shows relative luminous efficacy of a test panel with newly developed BaₓMg₁₋ₓO layer in different Ne—Xe gas mixture and their comparison to conventional MgO layer. The luminous efficacy is normalized to the efficacy of a test panel with conventional MgO layer in 7% Xe—Ne gas mixture. Compared to conventional MgO layer, the luminous efficacy of a test panel with BaₓMg₁₋ₓO layer is at least 40% higher the one with conventional MgO layer.

Because of much lower sustain voltage and firing voltage of BaₓMg₁₋ₓO layer at high Xe concentration, the panel with BaₓMg₁₋ₓO layer can reach much higher luminous efficacy with reasonable low voltage at high percentage of Xe in Ne—Xe gas mixture.

### EXAMPLE 2

Another example of low voltage protective layer is CaₓMg₁₋ₓO (0.01<x<1). The newly developed CaₓMg₁₋ₓO (0.01<x<1) film was formed by e-beam co-deposition of CaO and MgO. The film can also be formed by e-beam deposition from a single source material that is the mixture of CaO and MgO. 13″ panels using CaₓMg₁₋ₓO film instead of MgO film were fabricated with 15% Xe—Ne gas mixture. Hydroxide and carbonate formation can be prevented from forming on CaₓMg₁₋ₓO by sealing the panel in a moisture and CO₂ free environment.

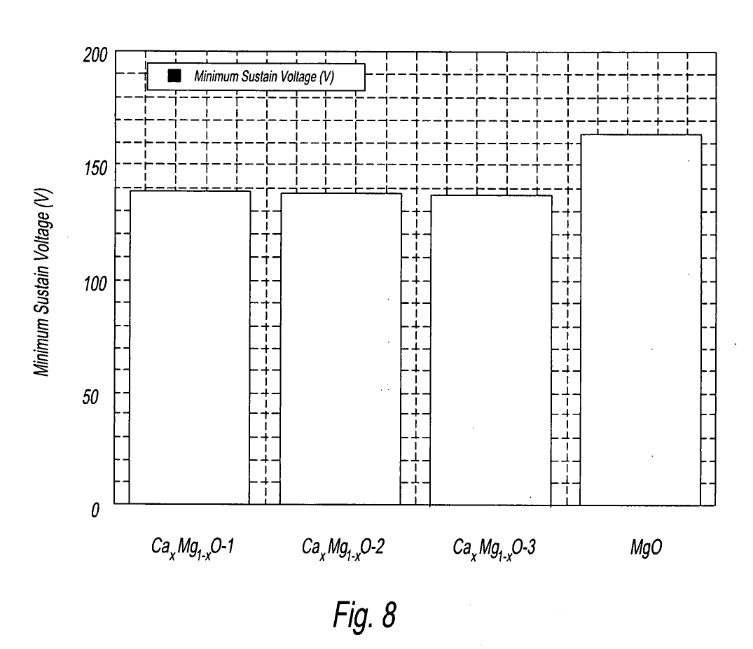

FIG. 8 shows minimum sustain voltage of 13″ test panels with various newly developed CaₓMg₁₋ₓO layer in 15% Xe—Ne gas mixture and their comparison to a normal MgO panel with same gas mixture. There is 20V to 25V reduction of minimum sustain voltage in those CaₓMg₁₋ₓO panels compared to a conventional MgO panel.

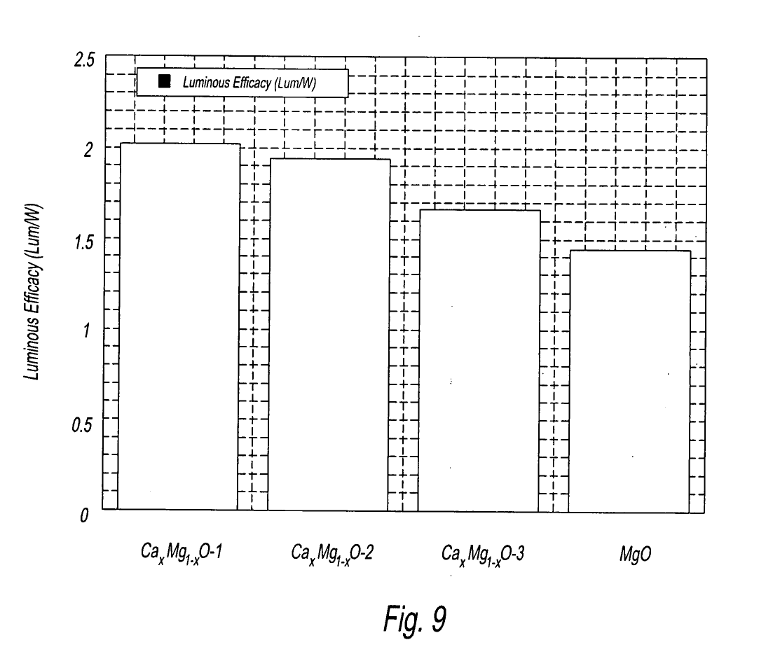

FIG. 9 shows the luminous efficacy of CaₓMg₁₋ₓO panel can be as high as 2.02 lum/W (in case of CaₓMg₁₋ₓO-3), 40% higher than the efficacy of a conventional MgO panel (1.44 lum/W). CaₓMg₁₋ₓO-1, CaₓMg₁₋ₓO-2, and CaₓMg₁₋ₓO-3 represents different mixture of CaO and MgO in CaₓMg₁₋ₓO layer.

The present invention has been described with particular reference to the preferred embodiments. It should be understood that the foregoing descriptions and examples are only illustrative of the invention. Various alternatives and modifications thereof can be devised by those skilled in the art without departing from the spirit and scope of the present invention. Accordingly, the present invention is intended to embrace all such alternatives, modifications, and variations that fall within the scope of the appended claims.

What is claimed is:

1. A gas discharge device comprising:
a plurality of electrodes; and
a low voltage protective layer deposited onto said electrodes such that said plurality of electrodes and said a low voltage protective layer form a vessel containing a dischargeable gas so that at least said low voltage protective layer is exposed to said dischargeable gas.

2. The gas discharge device of claim 1, further comprising:
a dielectric material between said electrodes and said low voltage protective layer.

3. The gas discharge device of claim 1, further comprising an anti-contamination layer on top of said low voltage protective layer, said anti-contamination layer comprising a material selected from the group consisting of: BeO, MgO, Al₂O₃, SiO₂, and/or a mixture of these materials

4. The gas discharge device of claim 1, further comprising a phosphor material.

5. The gas discharge device of claim 1, wherein said phosphor and said low voltage protective layer are all exposed to said dischargeable gas.

6. The gas discharge device of claim 1, wherein said phosphor layer comprises a phosphor material selected from the group consisting of: a red phosphor, a green phosphor, a blue phosphor and a combination thereof.

7. The gas discharge device of claim 1, wherein said vessel comprises a substrate.

8. The gas discharge device of claim 7, wherein said substrate comprises a plurality of barrier ribs perpendicular thereto.

9. The gas discharge device of claim 1, wherein said dischargeable gas comprises at least one element selected from the group consisting of: Xenon, Neon, Argon, Helium, Krypton, Mercury, Nitrogen, Oxygen, Fluorine and Sodium.

10. The gas discharge device of claim 1, wherein said gas discharge device is a fluorescent lamp.

11. The gas discharge device of claim 1, wherein said gas discharge device is a high intensity discharge lamp.

12. The gas discharge device of claim 1, wherein said gas discharge device is a plasma display.

13. The gas discharge device of claim 4, wherein said phosphor is selected from the group consisting of: a red phosphor, a green phosphor, a blue phosphor and a combination thereof.

14. The phosphor layer according to claim 4, further comprising:
a dielectric layer disposed between said plurality of electrodes and said phosphor layer.

15. The gas discharge device of claim 1, wherein said low voltage protective layer comprises a material represented by the formula:
MₓMg₁₋ₓO
wherein x is 0.01<x<1; and
wherein M is a metal selected from the group consisting of: Be, Ca, Sr, Ba, Ra, Sc, Y, Ti, Zr, Hf, V, Nb, Ta, Zn, Na, Al, and mixtures thereof.

16. The gas discharge device of claim 15, wherein said metal is selected from the group consisting of: Be, Ca, Sr, Ba, Ra, and mixtures thereof.

17. The gas discharge device of claim 15, wherein said low voltage protective layer is formed by co-deposition of magnesium oxide and oxides of said metals or co-deposition of the oxides of said metals.

18. The gas discharge device of claim 17, wherein said co-deposition of said oxides is carried out by a method selected from the group consisting of: e-beam evaporation, sputtering, molecular beam epithaxy (MBE), inkjet printing, screen printing, and spin coating.

19. The gas discharge device of claim 15, wherein said low voltage protective layer is formed by deposition of premixed oxides of said metals.

20. The gas discharge device of claim 19, wherein said deposition of said premixed oxides is carried out by a method selected from the group consisting of: e-beam evaporation, sputtering, chemical vapor deposition (CVD), molecular beam epithaxy (MBE), inkjet printing, screen printing, and spin coating.

21. The gas discharge device of claim 1, wherein said low voltage protective layer has a lower operating voltage than MgO.

22. The gas discharge device of claim 21, wherein said low voltage protective layer improves luminous efficacy of plasma display panels by increasing the effective secondary electron emission from said protective layer under discharge of inert gases.

23. The gas discharge device of claim 21, wherein said lower operating voltage is selected from the group consisting of: low sustain voltage and/or low addressing voltage, wherein said low sustain voltage reduces erosion rate of said protective layer and said lower addressing voltage reduces cost of data driving circuits.

24. The gas discharge device of claim 1, wherein said low voltage protective layer is deposited on top of an electrode such that said low voltage protective layer is directly exposed to dischargeable gas.

25. The gas discharge device of claim 2, wherein said low voltage protective layer is deposited on the surface of said dielectric layer disposed on said plurality of electrodes.

26. The gas discharge device of claim 1, wherein said gas discharge device is sealed in a moisture and/or CO₂ free environment or is sealed in an evacuated environment.

27. A plasma display, comprising:
a first substrate having a plurality of barrier ribs;
a second substrate disposed above said first substrate;
a plurality of electrodes on said first and said second substrates separated by said plurality of barrier ribs; and
a low voltage protective layer deposited between said plurality of electrodes on said first substrate and said second substrate such that said barrier ribs between said first substrate and said low voltage protective layer form a vessel containing a dischargeable gas so that at least said low voltage protective layer is exposed to said dischargeable gas.

28. The plasma display of claim 27, wherein said plasma display is sealed in a moisture and/or CO₂ free environment or is sealed in an evacuated environment.

29. The plasma display of claim 27, wherein said low voltage protective layer is disposed on a portion of said front plate and aligned with at least one electrode on front plate.

30. The plasma display according to claim 27, wherein said low voltage protective layer comprises a material represented by the formula:
MₓMg₁₋ₓO
wherein x is 0.01<x<1; and
wherein M is a metal selected from the group consisting of: Be, Ca, Sr, Ba, Ra, Sc, Y, Ti, Zr, Hf, V, Nb, Ta, Zn, Na, Al, and mixtures thereof.

31. A plasma display panel, comprising:
a front plate having scan electrodes and sustain electrodes for each row of sub-pixel sites;
a back plate having a plurality of column address electrodes disposed thereon;
a dielectric layer covering said column address electrodes;
a plurality of barrier ribs disposed above said dielectric layer separating said column address electrodes and being in spaced adjacency therewith;
a red phosphor layer, a green phosphor layer and blue phosphor layer sequentially disposed on top of said dielectric layer between said barrier ribs; and
a low voltage protective layer deposited on top of the dielectric layer which covers scan electrodes and sustain electrodes on said front plate such that said barrier ribs and phosphor layer on said back form a panel containing a dischargeable gas so that at least said low voltage protective layer and said phosphor layers are exposed to said dischargeable gas.

32. A composition represented by the formula:
MₓMg₁₋ₓO
wherein x is 0.01<x<1;
wherein M is a metal selected from the group consisting of: Be, Ca, Sr, Ba, Ra, Sc, Y, Ti, Zr, Hf, V, Nb, Ta, Zn, Na, Al, and mixtures thereof; and
wherein said composition is in the form of a low voltage protective layer having a band gap from about 3.5 eV to about 7 eV.

33. The composition of claim 32, wherein M is a metal selected from Be, Ca, Sr, Ba, Ra, and mixtures thereof.
